(19) United States
(12) Patent Application Publication
(10) Pub. No.: US 2010/0219737 A1
(43) Pub. Date: Sep. 2, 2010

(54) FURNACE-MADE FEEDTHROUGH FEATURING WRAP-AROUND GLASS-TO-METAL SEAL

(75) Inventors: Peter A. Werner, Batavia, IL (US); John T. Randall, Oswego, IL (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/279,760

(22) PCT Filed: Feb. 5, 2007
(86) PCT No.: PCT/US2007/061593

§ 371 Date: Aug. 18, 2008

Related U.S. Application Data
(60) Provisional application No. 60/775,253, filed on Feb. 21, 2006.

(51) Int. Cl. H01J 19/42; C03C 27/02; B32B 1/08; B32B 3/10

(52) U.S. Cl. 313/243; 65/59.1; 428/34.4; 428/131

(57) ABSTRACT

An x-ray tube (10) includes a feedthrough (30) for feeding electric wires (32) from an exterior of the x-ray tube into an evacuated interior. The feedthrough includes a glass plug (42) having an annular groove (46) in which a tubular end (36a) of a Kovar sleeve (34) is received and thermally fused. The glass plug further has a plurality of bores (44) through which leads (32) are received, which leads have a Kovar section (40) which is received in the bores and thermally fused to the glass plug.

The present invention relates to the glass working arts. It finds particular application in conjunction with feedthroughs for high power x-ray tubes and will be described with particular reference thereto. However, it is to be appreciated that the invention will also find application in conjunction with other vacuum tubes, glass pressure or vacuum vessels, and the like.

Typically, x-ray tubes include an anode and a cathode mounted inside of an evacuated glass envelope or frame. Electrical power is usually provided to the cathode by way of a feedthrough which feeds a plurality of electrical conductors through the glass frame.

In one prior feedthrough implementation, a Kovar sleeve which is flared at the top to be welded and sealed to portions of a metallic cathode assembly. Kovar, of course, is a high temperature conductive alloy which has an expansion of coefficient like that of glass and which fuses to glass at glass-softening temperatures. A plurality of leads extends through the Kovar cylinder from the atmospheric exterior to the interior of the tube. In order to form a vacuum-tight seal, a glass plug is provided which has an outer diameter which permits it to fit snugly inside the Kovar cylinder and axial, interior bores through which the leads are received. Each lead is spliced with a Kovar segment for the portion which passes through the glass cylinder. The assembly of the Kovar sleeve with the glass cylinder inserted into it and the Kovar sections of the leads received in the bores of the glass cylinder is then placed in an oven of about 1000° C. to fuse the glass cylinder to the interior surface of the Kovar sleeve and around the exterior surfaces of the Kovar segments of the leads.

Although this technique forms an effective vacuum seal, a small percentage of the seals fail after the flange of the Kovar sleeve is welded to other portions of the cathode assembly. The present inventor theorizes that the heating of the flange to about 200° C. during welding heats the conductive Kovar sleeve which heats and expands more rapidly than the more thermally insulative glass cylinder, occasionally causing a slight flaw in the glass cylinder to Kovar sleeve seal. Unfortunately, this leak is typically so slight that it is not detected until assembly of the tube has been completed and the tube evacuated, i.e., substantially at the end of the manufacturing process. Leaking tubes are scrapped.

The present invention provides a new and improved sealing technique which overcomes the above-referenced problems and others.

In accordance with one aspect of the present invention, a feedthrough for a vacuum or pressure vessel is provided. The feedthrough includes a sleeve with a tubular end made of a conductive material which thermally fuses to glass. A glass plug defines a recess in one face which is dimensioned to receive the tubular end of the sleeve. The glass plug further defines at least one bore which is sized to receive a segment of a conductive material which thermally fuses to glass of an electrical lead. The glass plug is thermally fused to the tubular end of the sleeve and the segment of the electrical lead.

In accordance with another aspect of the present invention, a vacuum tube is provided which includes a vacuum-tight frame, an anode and cathode mounted in the frame, and a feedthrough as set forth above.

In accordance with another aspect of the present invention, a glass plug is provided for use in manufacturing the feedthrough presented above.

In accordance with another aspect, a method of manufacturing a feedthrough for a pressure or vacuum vessel is provided. A glass plug which has a bore extending through it and a recess defined in one face leaving a peripheral annular ring is formed. An electrical lead with a segment of a conductive material which thermally fuses to glass is passed through the bore and positioned with the segment in the bore. The glass plug and a sleeve of a conductive material which thermally fuses to the glass are positioned relative to each other such that a tubular end of the sleeve is received in the recess. Inserting the segment of the electrical leads into the bore and the positioning of the tubular end of the sleeve in the recess are performed in either order. The glass plug, the sleeve, and the electrical leads are heated at a sufficient temperature and for a sufficient duration to fuse the glass plug to the electrical lead segment and the tubular end of the sleeve in a vacuum-tight relationship.

In accordance with another aspect, a feedthrough made by the above-method is provided.

In accordance with another aspect, a vacuum tube is provided which includes a feedthrough manufactured by the above method.

One advantage of the present invention is that it provides feedthroughs with more reliable vacuum seals.

Another advantage of the present invention resides in an improved technique for sealing glass plugs to Kovar sleeves.

Still further advantages of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

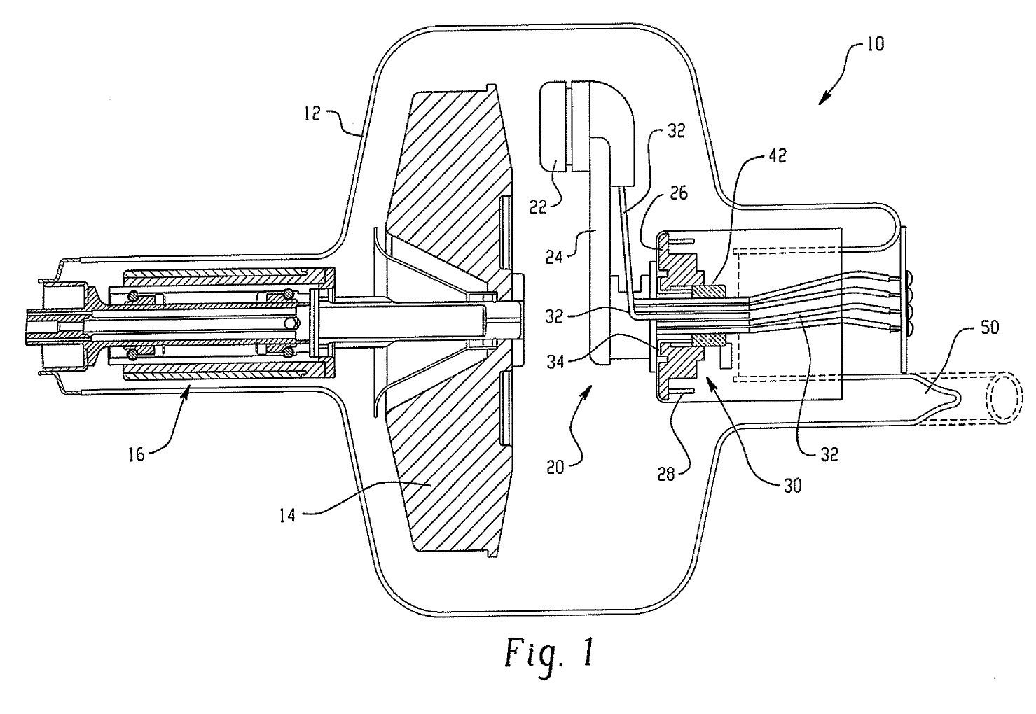

FIG. 1 is a diagrammatic, cross-sectional view of a rotating anode x-ray tube which includes a feedthrough in accordance with the present invention;

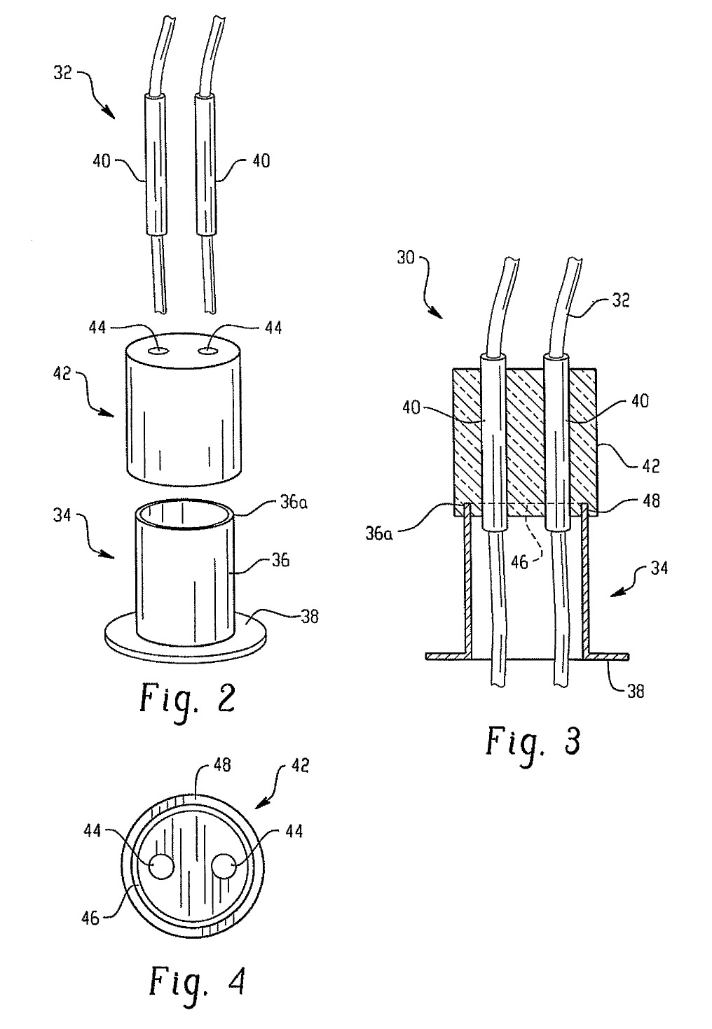

FIG. 2 is an expanded view of the feedthrough of FIG. 1 showing only two feedthroughs (for simplicity of illustration) of assembly procedures; and,

FIG. 3 is a cross-sectional view of FIG. 2 in an assembled state; and,

FIG. 4 is an end view of the glass plug of FIGS. 2 and 3.

With reference to FIG. 1, a rotating anode type x-ray tube 10 includes a glass envelope or frame 12. An anode 14 and an associated bearing assembly 16 are mounted in a vacuum tight relationship at one end of the glass frame. A cathode assembly 20, including a cathode cup 22, an arm 24, a header 26, and a getter 28, is mounted to an opposite end of the glass frame in a vacuum-tight relationship. A feedthrough assembly 30 passes a plurality of wires 32 from the ambient atmosphere into the vacuum and provides a vacuum tight seal.

With continuing reference to FIG. 1 and further reference to FIGS. 2, 3, and 4 (in which only two of the four wires illustrated in FIG. 1 are shown for simplicity), the feedthrough 30 includes a Kovar sleeve 34 having a tubular portion 36 and a flange 38. Of course, materials other than Kovar which are thermally fused to glass are also contemplated. The flange, in a subsequent operation, will be welded to the cathode header 26 in a vacuum-tight relationship.

The wires 32 each include a Kovar segment 40 having a length comparable to a length of a glass plug or cylinder 42. The Kovar segments 40 are connected with more flexible, bendable, and potentially better conductive leads on either end for interconnection with the cathode cup and optionally the getter on the vacuum side and with connection points for interconnecting the vacuum tube with sources of power and control at the atmosphere side. In the embodiment of FIG. 1, three nickel wires are shown extending to the cathode cup 22 to control a filament or filaments and, optionally, a grid for focusing the electrical beam that is accelerated from the cathode to the anode.

The glass plug 42 includes bores 44 which are sized to receive the electrical leads and particularly the Kovar segments 40 slidably but snugly therein. At an end toward the Kovar sleeve 34, the glass plug includes an annular recess such as a groove or channel 46 of a diameter and width to match a corresponding end 36a of the Kovar sleeve tubular section 36. The groove is dimensioned such that the Kovar sleeve is received slidably, but snugly therein. When the end of the Kovar sleeve is received in the groove, a peripheral portion of the glass plug forms a ring 48 around the outer periphery of the Kovar sleeve cylindrical portion. Once fused together, the ring 48 functions as a peripheral restraint that controls expansion of the end of the tubular section 36. In the groove or channel embodiment, the glass plug also fuses to an inner surface of the Kovar sleeve. In an exemplary embodiment, the groove or channel 46 is about 1.5 mm deep and about 0.75 mm wide. The annular ring 48 is also about 1.5 mm wide. Of course, the channel and ring can have other dimensions. For example, the ring can be 1 mm wide or 2 mm side and the groove could be 2 mm deep. Of course, the sleeve tubular portion 36 and the annular recess 46 can be circular, elliptical, hexagonal, or the like.

During assembly, the leads 32 are fed through the bores 44 in the glass plug 42 until the Kovar sections 40 are received in and span the bores. The glass plug with the leads in place is positioned on the Kovar sleeve with the Kovar sleeve received in the groove or channel 46. This assembly is then heated to a sufficient temperature and for a sufficient duration, e.g., about 900-1000° C. for about 30-60 minutes, to fuse the glass plug 42 to the Kovar sections 40 and to the Kovar sleeve 34, all in a vacuum-tight relationship. The feedthrough assembly 30 is subsequently positioned on the cathode header 26 and welded in place. After all of the cathode and anode parts are assembled and sealed into the glass frame, a vacuum is drawn through a tubular extension 50. Once the tube is fully degassed, the tube 50 is heated and sealed. The getter 28 is flashed, optionally through power applied through one of the leads 32, which activates it to absorb any residual gas present or which may develop in the frame.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

Having thus described the preferred embodiments, the invention is now claimed to be:

1. A feedthrough (30) for a pressure or vacuum vessel comprising:
a sleeve (34) of a conductive material which thermally fuses to glass and having a tubular end (36a);
a glass plug (42) which defines a recess (46) in one face dimensioned to receive the tubular end of the sleeve (34) therein, the glass plug further defining at least one bore (44) longitudinally therethrough sized to receive a segment (40) of an electrical lead (32), the segment (40) being formed of a conductive material which thermally fuses to glass, the glass plug (42) being thermally fused to the tubular end (36a) of the sleeve (34) and the segment (40).

2. The feedthrough according to claim 1, wherein the conductive material which fuses to glass includes a Kovar alloy.

3. The feedthrough according to claim 1, wherein the recess (46) defines a ring (48) of the glass plug (42) which ring peripherally surrounds and is fused to a peripheral face of the tubular end (36a) of the sleeve (34).

4. The feedthrough according to claim 1, wherein the glass plug (42) has a plurality of bores (44) and a corresponding plurality of electrical leads with Kovar sections (40) are inserted therethrough.

5. The feedthrough according to claim 1, wherein the glass plug is cylindrical.

6. The feedthrough according to claim 1, wherein the electrically conductive glass fusible sleeve (34) is cylindrical and the recess (46) is a cylindrical groove in which the tubular end (36a) of the sleeve (34) is received and fused.

7. The feedthrough according to claim 1, wherein the recess (46) is less than 2 mm deep.

8. A vacuum tube including:
a vacuum-tight frame (12);
an anode (14) mounted within the frame;
a cathode (20) mounted in the frame; and,
a feedthrough according to claim 1, for feeding wires from an exterior of the frame into an interior of the frame in a vacuum-tight relationship.

9. The vacuum tube according to claim 8, wherein the anode (14) is rotatably mounted on a bearing (16).

10. A glass plug for use in manufacturing the feedthrough according to claim 1.

11. A method of manufacturing a feedthrough (30) for a pressure or vacuum vessel comprising:
forming a glass plug (42) having at least one bore (44) extending longitudinally therethrough and a recess (46) defined in one end, leaving an annular ring (48) therearound;
passing an electrical lead (32) with a segment (40) of a conductive material which thermally fuses to glass through the bore (44) and positioning the segment (40) in the bore (44);
positioning the glass plug (42) and a sleeve (34) of a conductive material which thermally fuses to glass such that a tubular end (36a) of the sleeve (34) is received in the recess (46), the inserting of the segment (40) of the electrical leads (32) into the bore (40) and the positioning of the tubular end (36a) of the sleeve (34) in the recess (46) being performed in either order;
heating the glass plug (42), the sleeve (34), and the electrical leads (32) at a sufficient temperature and for a sufficient duration to fuse the glass plug (42) to the electrical lead segment (40) and the tubular end (36a) of the sleeve (34) in a vacuum-tight relationship.

12. The method as set forth in claim 11, wherein the conductive material which thermally fuses to glass includes a Kovar alloy.

13. The method according to claim 12, wherein fashioning the glass plug (42) includes forming a plurality of longitudinal bores (44) and in the inserting step, a plurality of electrical leads (32) with Kovar segments (40) are inserted therein.

14. The method according to claim 12, wherein forming the Kovar sleeve includes forming the sleeve with a peripheral flange (38) and an end opposite to the tubular end (36a) and further including:
welding the flange (38) to an associated assembly in a vacuum-tight relationship.

15. A feedthrough (30) made according to the method of claim 11.

16. A vacuum tube (10) including a feedthrough manufactured according to the method of claim 11.

17. A feedthrough (30) for a pressure or vacuum vessel comprising:
a sleeve (34) having a first end (36a) of a material which thermally fuses to glass;
a glass plug (42) defining at least one bore (44) through which an electrical lead (32) passes, the glass plug (42) being thermally fused to the sleeve (34);
a glass ring (48) disposed around an outer periphery of the sleeve (34) and being thermally fused thereto.

18. The feedthrough according to claim 17, wherein the glass plug (42) and the electrical lead received through the bore (44) are thermally fused in a vacuum or pressure tight relationship.

19. The feedthrough according to claim 18, wherein the glass plug (42) is thermally fused to an inner peripheral surface of the sleeve first end (36a) to form a vacuum or pressure tight seal therebetween.

20. The feedthrough according to claim 18 wherein the glass plug (42) includes a plurality of bores (44) and further including a plurality of electrical leads (32) each received in one of the bores (44) and thermally fused to the glass plug (42).

21. The feedthrough according to claim 18 wherein the glass plug (42) has a recess (46) defining one face, the glass ring (48) extending around the recess (48) and being integral with the glass plug.
